(19) United States
(12) Patent Application Publication
(10) Pub. No.: US 2026/0003763 A1
(43) Pub. Date: Jan. 1, 2026

(54) SYSTEMS AND METHODS FOR PERFORMING DYNAMIC SAMPLING

(71) Applicant: WELLS FARGO BANK, N.A., San Francisco, CA (US)

(72) Inventors: Girish Tavag, Bangalore (IN); Pavan Kumar Polavarapu, Hyderabad (IN); Eric Chho, Park City, UT (US); Jonah J. Zirkle, Norwalk, IA (US); Chintada Subramanyam, Hyderabad (IN)

(21) Appl. No.: 18/760,842

(22) Filed: Jul. 1, 2024

(51) Int. Cl. G06F 11/34; G06F 11/30

(52) U.S. Cl. CPC G06F 11/3466; G06F 11/302

(57) ABSTRACT

Systems and method of dynamic sampling including: providing, to a client device, an instrumented application comprising an agent, wherein the agent is configured to log a set of telemetry data associated with performance metrics of the instrumented application and a time period associated with the set of telemetry data; determining an overall data throughput associated with the instrumented application based on the set of telemetry data; and comparing the overall data throughput to a first and second threshold, wherein when the overall data throughput exceeds the first threshold: update an application performance monitoring server to set a sampling rate of the application performance monitoring server to a reduced sampling rate; and when the overall data throughput is lower than the second threshold: update the application performance monitoring server to set the sampling rate to the increased sampling rate.

### FIELD OF INVENTION

The present disclosure generally relates to dynamic sampling of telemetry data, and more particularly to systems and methods for adjusting the sampling of telemetry data based on data throughput while maintaining availability of an application to users.

### BACKGROUND

Enterprises tasked with managing high throughputs of data, such as banks, may store and manage hundreds of terabytes of newly generated data a day. As a result, these enterprises often dedicate large amounts of resources to storing and retaining the data. The amount of resources that an enterprise dedicates to the management of its data is generally proportional to the amount of data it must manage, therefore to reduce costs, enterprises seek to reduce the amount of data they must manage, such as by reducing the amount telemetry data they must collect to observe the operation of their services. Current enterprise tools lack sampling architecture that dynamically adjusts sampling rates for services based on data throughput of services during periods of high data traffic while maintaining availability of the services.

### SUMMARY

In an aspect, an example method includes: providing, to a first client device, a first instance of a first instrumented application comprising a first agent, wherein the first agent is configured to log a first set of telemetry data associated with performance metrics of the first instance of the first instrumented application and a time period associated with the first set of telemetry data; determining an overall data throughput associated with the first instrumented application based on the first set of telemetry data; and comparing the overall data throughput to a first threshold, wherein when the overall data throughput exceeds the first threshold: determine a reduced sampling rate to reduce the overall data throughput below the first threshold; and update an application performance monitoring server to set a sampling rate of the application performance monitoring server to the reduced sampling rate; comparing the overall data throughput to a second threshold lower than the first threshold, wherein when the overall data throughput is lower than the second threshold: determine an increased sampling rate to increase the overall data throughput above the second threshold; and update the application performance monitoring server to set the sampling rate to the increased sampling rate; and when the overall data throughput does not exceed the first threshold or is not lower than the second threshold, store the first set of telemetry data in memory. The performance metrics of the instrumented application may include one or more of: latency, resource usage, and availability of the instrumented application.

In a further aspect, further example methods may include retaining the first set of telemetry data based on enterprise rules associated with the first instrumented application when the overall data throughput does not exceed the first threshold.

In another aspect, further example methods may include providing, to a second client device, a second instance of the first instrumented application including a second agent, wherein the second agent is configured to log a second set of telemetry data and a time period associated with the second set of telemetry data, wherein the second set of telemetry data is associated with performance metrics of the second instance of the first instrumented application; determining a data throughput associated with the second instance of the first instrumented application based on the second set of telemetry data; and wherein the overall data throughput is based on the data throughput associated with the first instance of the first instrumented application and the data throughput associated with the second instance of the first instrumented application.

In a further aspect, further example methods may include wherein when the overall data throughput exceeds the first threshold, generate a request to set the sampling rate to the reduced sampling rate; transmit the request; and receive an approval to set the sampling rate to the reduced sampling rate.

In another aspect, the example method may include providing, to a second client device, a first instance of a second instrumented application comprising a second agent, wherein the second agent is configured to log a second set of telemetry data associated with performance metrics of the second instrumented application and a time period associated with the second set of telemetry data; determining a data throughput associated with the second instrumented application based on the second set of telemetry data; and wherein the overall data throughput is based on the data throughput associated with the first instrumented application and the data throughput associated with the second instrumented application.

The above methods can be implemented as computer-executable program instructions stored in a non-transitory, tangible computer-readable medium or media and/or operating within a system including one or more processors or other processing device and memory. For example, the above methods may be implemented into a cloud service executed on cloud service provider infrastructure, which may include various servers, processors, and databases.

### BRIEF DESCRIPTION

A full and enabling disclosure is set forth more particularly in the remainder of the specification. The specification makes reference to the following appended figures.

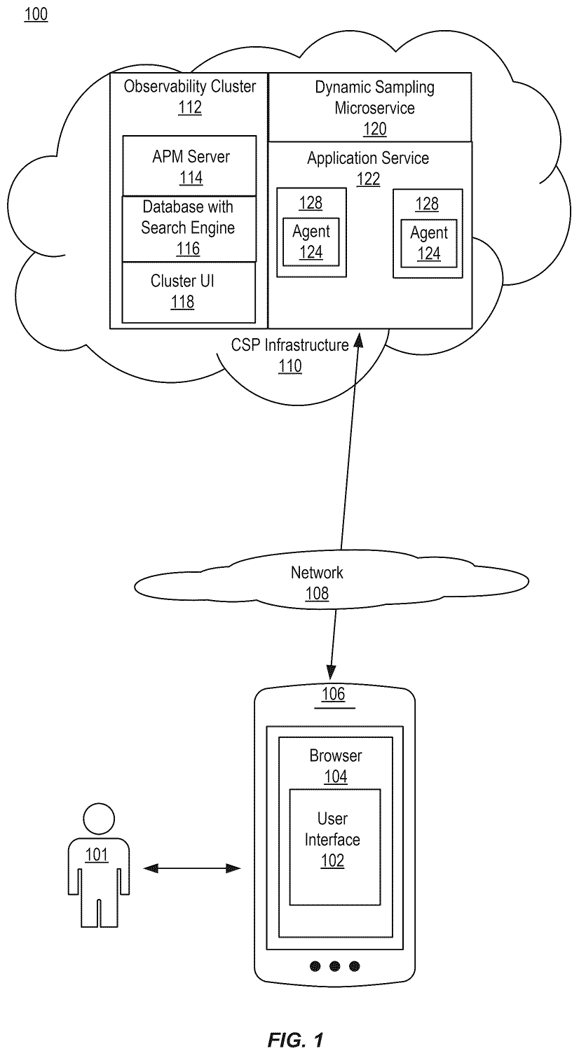

FIG. 1 illustrates an example system for dynamic sampling.

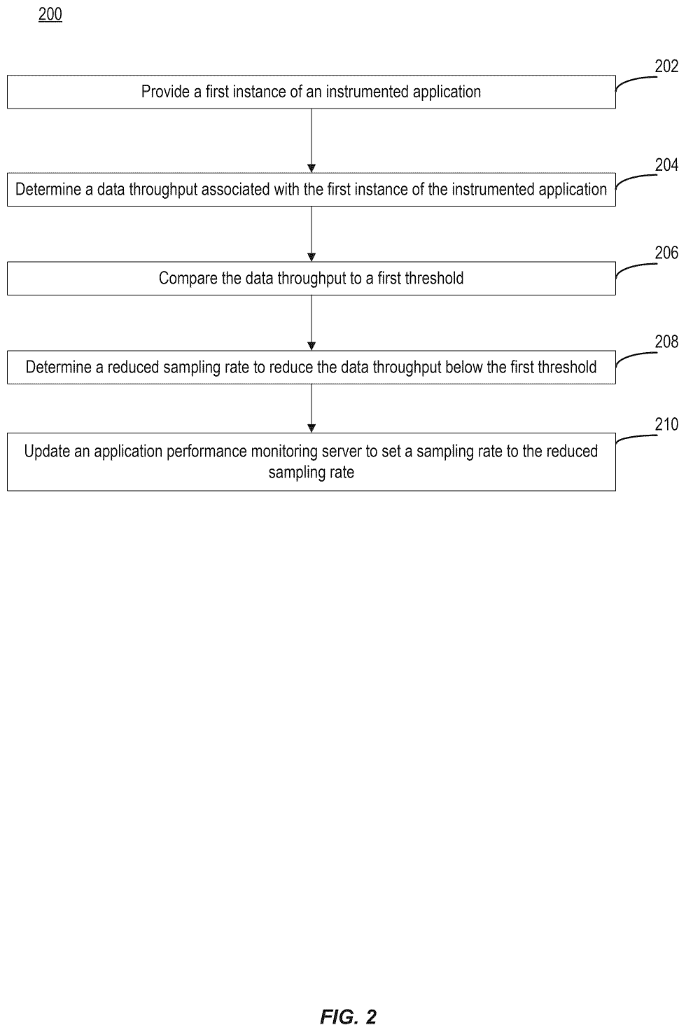

FIG. 2 illustrates a flow chart for a method of dynamic sampling.

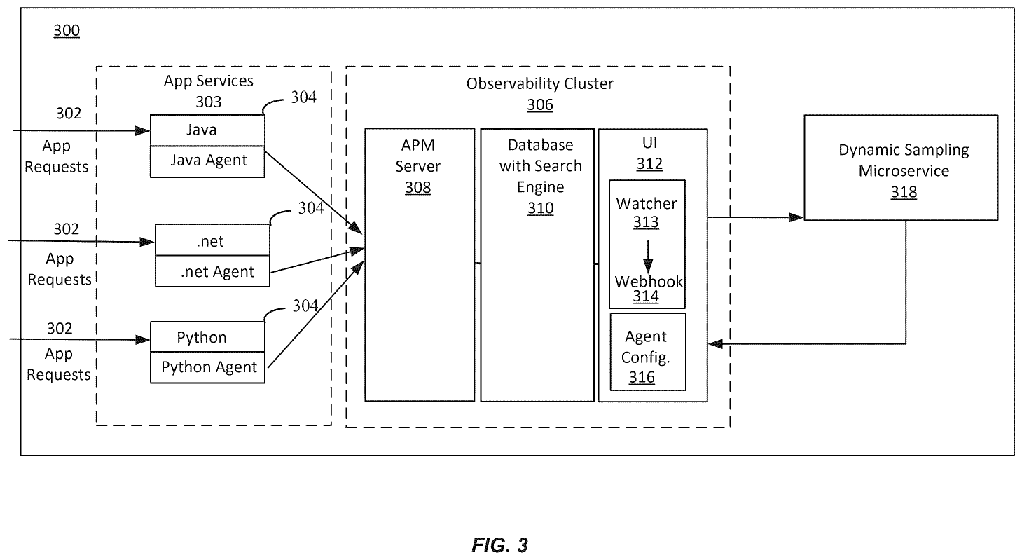

FIG. 3 illustrates an example of system architecture for dynamic sampling.

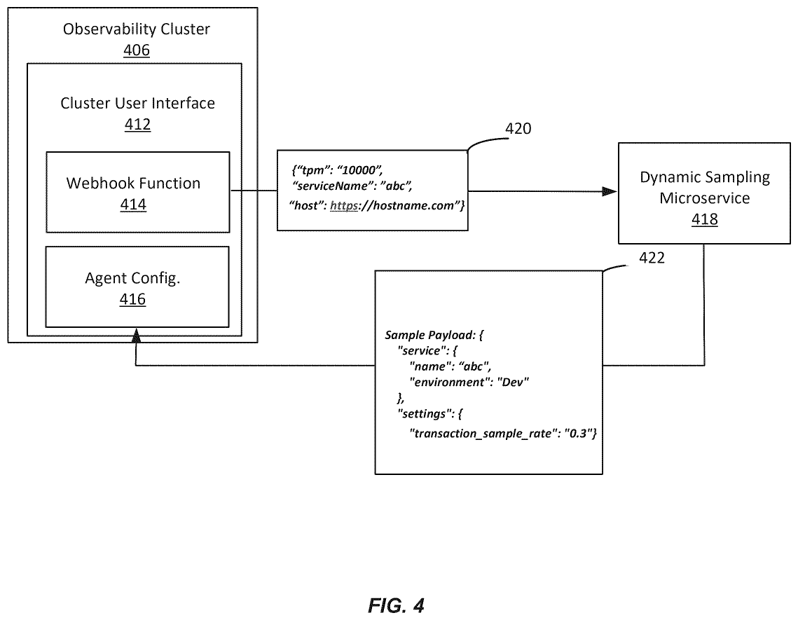

FIG. 4 illustrates example payloads provided from the webhook function and the dynamic sampling microservice to adjust sampling rates.

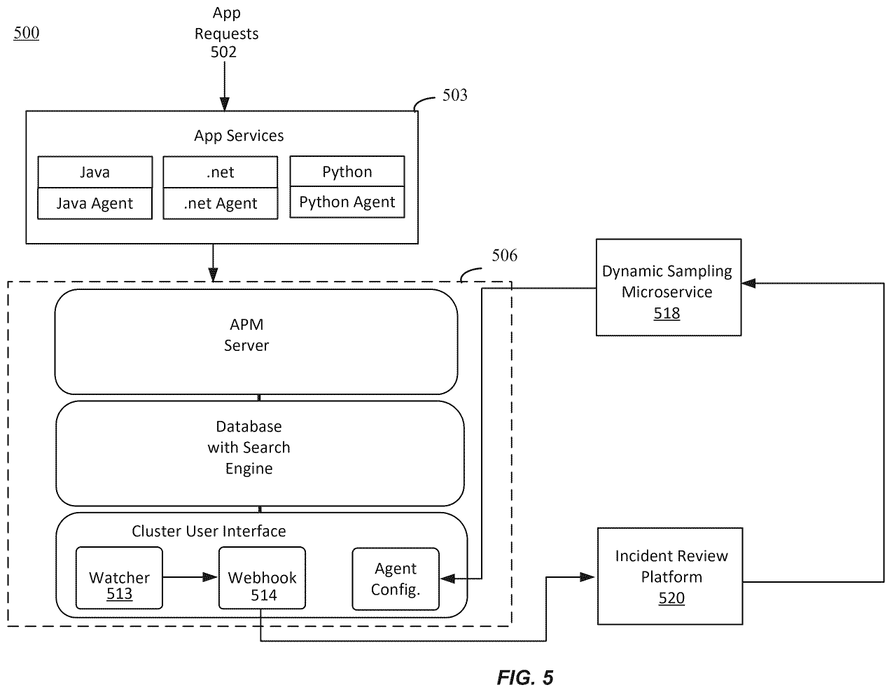

FIG. 5 illustrates an example of system architecture for dynamic sampling including a review application.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Embodiment of a System for Dynamic Sampling

In one illustrative embodiment, a system for dynamic sampling includes a dynamic sampling microservice that may adjust sampling rates of an application performance monitoring (APM) server associated with an instrumented application based on data throughput of the instrumented application. The instrumented application may include a software agent, such as a computer program that may read configurations of an application performance monitoring (APM) server to set an initial sampling rate of the instrumented application. In further examples, the software agent may be a computer program configured to collect telemetry data associated with execution of the instrumented application. For example, the telemetry data may include various performance metrics, such as data representing the application's availability, security, reliability, and latency.

The dynamic sampling microservice may invoke the application performance monitoring (APM) server to throttle samples from the instrumented application that exceed a sampling rate set by the dynamic sampling microservice. Cloud service provider infrastructure, such as various servers, may provide the application to a client device. In further examples, users may access the application through a browser, or a user's device (e.g., the client device) may execute the application locally, such as executing the application on a personal computer or smartphone.

The instrumented application may have multiple instances. For example, a plurality of users may access separate instances of the instrumented application using different user devices. Users may provide application requests to the instrumented application by providing input to a user interface requesting the instrumented application perform an action. For example, where the instrumented application is a banking application, users may provide application requests such as transferring funds, applying for a loan, and checking an account balance. In some examples, the application requests may be associated with background processes of the application, such as checking notifications, virus scans, system updates, and memory management.

The instrumented application receives app requests from users or from background processes of executing the instrumented application. The instrumented application's software agent collects telemetry data associated with the performance of the app requests initially set by the application performance monitoring (APM) server. For example, the software agent may collect 30% of the telemetry data produced during execution of the instrumented application. In such an example, the agent may have a sampling rate of 0.3.

The software agent may log the sampled telemetry data and the instrumented application may provide the log to an observability cluster. The observability cluster may include one or more servers to monitor performance of the instrumented applications based on the log of sampled telemetry data. The observability cluster may also include a database with a search engine by which administrators (e.g., employees of an enterprise providing or maintaining the observability cluster) may search through the platform for sampled telemetry data. The user interface may also allow administrators to edit and review the sampled telemetry data. For example, administrators may use the observability cluster to search for sampled telemetry data associated with the instrumented application's latency and review various attributes of the sampled telemetry data to troubleshoot performance issues of the instrumented application.

The observability cluster may determine a data throughput of instrumented applications based on the logs received by the observability cluster. Data throughput is a rate of data received from a source (e.g., the instrumented application) and may be measured in requests per second (requests/s) or bits per second (b/s). The observability cluster may track the data throughput of instrumented applications based on the received logs of telemetry data. Administrators may set thresholds to adjust allowable ranges of data throughputs from instrumented applications.

By way of a non-limiting example, administrators may set a first threshold at 2000 requests/s and a second threshold at 500 requests/s to set the data throughput between 500 requests/s and 2000 requests/s. When the data throughput is less than the second threshold or greater than the first threshold, the observability cluster may trigger a request to the dynamic sampling microservice to adjust the sampling rate of the instrumented application to reduce the data throughput to fall within the range between the first threshold and the second threshold. In some examples, the observability cluster may only set a maximum data throughput and trigger a request to the dynamic sampling microservice that the data throughput not exceed the maximum data throughput.

The dynamic sampling microservice generates a payload based on the request from the observability cluster, which the dynamic sampling microservice provides to the observability cluster. The payload may be a packet or other data unit including instructions to direct the observability cluster. For example, the observability cluster throttles data from the instrumented application exceeding the sampling rate based on the payload. In some examples, the dynamic sampling microservice may calculate a sampling rate based on business rules established by the enterprise providing the dynamic sampling microservice. The payload may include instructions to the observability cluster to set the sampling rate at a level that adjusts the data throughput to a rate between the first threshold and the second threshold.

### Illustrative Example for a System for Dynamic Sampling

In one illustrative example, the system for dynamic sampling may include a plurality of applications, each application having a plurality of instances. For example, the system may include three applications, each application having a plurality of instances. The individual instances may be associated with individual users interacting with one of the three applications. Users, across the plurality of instances of the three applications may provide inputs to the applications to generate application requests. Software agents associated with the three applications may collect logs of telemetry data and the three applications may provide the logs to an observability cluster.

The observability cluster may determine data throughput for each application. In some examples, the observability cluster may determine a total data throughput representing an overall data throughput of the three applications. Administrators may set thresholds to adjust allowable ranges of data throughputs to adjust the total data throughput and data throughput of individual applications. When the total data throughput deviates from a predetermined allowable range of data throughput, the observability cluster may trigger a request to the dynamic sampling microservice to adjust the sampling rates of the observability cluster, thereby reducing the data throughput so that the data throughput falls within the predetermined allowable range.

The observability cluster may determine a sampling rate for the three applications and trigger a watcher of the observability cluster to generate a payload which the watcher or the observability cluster may transmit to the dynamic sampling microservice. An example payload transmitted from the watcher to the dynamic sampling microservice is below:

{“tpm”: “10000”,
“serviceName”: ”abc”,
“host”: https://hostname.com”}

The payload may be a message or other data unit including instructions to the observability cluster to adjust the sampling rate of the observability cluster. The observability cluster may throttle data exceeding the sampling rate of individual applications from the three applications to lower the total data throughput. An example payload generated by the dynamic sampling microservice adjusting the sampling rate is below:

```
Sample Payload: {
  ″service″: {
  ″name″: “abc″,
    ″environment″: ″Dev″
  },
  ″settings″: {
  ″transaction_sample_rate″: ″0.3″}
```

### System for Dynamic Sampling

FIG. 1 illustrates a system 100 for dynamic sampling. The system 100 includes one or more client devices 106, such as a smartphone or personal computer. Users 101 may provide input to a user interface 102 of applications 128 accessible through a browser 104. User inputs to the user interface 102 are provided over a network 108 (e.g., the internet), to application services executed on cloud service provider infrastructure 110. In some examples, the applications 128 may be executed on the client device.

The applications 128 may include an agent 124. The agent 124 is a computer program which logs telemetry data associated with applications 128. The agent 124 samples telemetry data based on a preset sampling rate, logs the sampled telemetry data, and exports logs of the sampled telemetry data to an observability cluster 112.

The cloud service provider infrastructure 110 may include various software and hardware components, such as processors, servers, and databases to execute the cloud services. Various clouds may execute on the cloud service provider infrastructure 110, such as the observability cluster 112, a dynamic sampling microservice 120, and the application services 122.

The observability cluster 112 may include an application performance monitoring (APM) server 114, a database with search engine 116, and a cluster user interface (UI) 118. The application performance monitoring server 114 may include one or more various servers, provided by the cloud service provider infrastructure 110, which monitors performance metrics (e.g., availability, reliability, and latency) of applications 128 provided by application services 122. The application performance monitoring server 114 performs analytics on logs of telemetry data it receives from the applications 128, such as reviewing latency, availability, reliability, and security concerns associated with the applications 128. The observability cluster 112 may store results analyzing the logs in the database with search engine 116. Administrators of the clouds services may access logs and the analytics through the cluster user interface (UI) 118. In some examples, the cluster user interface (UI) 118 may be data visualization dashboard such as Kibana.

The database with search engine 116 allow for administrators of the cloud service, such as employees of an enterprise providing the cloud service, to search and review logs of sampled telemetry data. In some examples, the database with search engine 116 may be ElasticSearch.

The agent 124 logs the sampled telemetry data and the application 128 provides the log and a time period associated with the log to the observability cluster 112. In some examples, the time period associated with the log is part of the log. In further examples, the time period is the time period during which the log was transmitted from the agent to the observability cluster 112. The observability cluster 112 determines a data throughput for the applications 128 based on the log and the time period and compares the data throughput to predetermined threshold values. The predetermined threshold values may be set by administrators of the observability cluster 112. When the data throughput exceeds or falls below the predetermined thresholds, the observability cluster may trigger the dynamic sampling microservice 120 to generate instructions to reduce the sampling rate of observability cluster to adjust the data throughput to be within the predetermined range. For example, the dynamic sampling microservice 120 may generate and provide to the observability cluster 112 a payload with instructions to set the sampling rate of the observability cluster 112 or the application performance monitoring (APM) server 114 to adjust the data throughput to be within a predetermined range.

In some examples, the dynamic sampling microservice 120 provides the payload to an agent configuration module at the observability cluster 112, which may communicate application performance monitoring server 114 to adjust the sampling rate.

### Illustrative Method for Dynamic Sampling

FIG. 2 is a flowchart showing illustrative method 200 for operating a system for robotic processing automation. In some examples, some of the steps in the flow chart of FIG. 2 are implemented in program code executed by a processor, for example, the processor in a general-purpose computer, mobile device, or server. In some examples, these steps are implemented by a group of processors. In further examples the steps shown in FIG. 2 are performed in a different order or one or more steps may be skipped. Alternatively, in some examples, additional steps not shown in FIG. 2 may be performed.

At block 202, the method 200 includes providing a first instance of an instrumented application. The instrumented application may include a first agent. As further described in the description of FIG. 1, the agent may be a computer program associated with an application configured to log telemetry data associated with the first instance of the application.

Cloud service provider infrastructure, as further described in the description of FIG. 1, may provide the first instance of the application to a client device of a user, and the first instance may be accessible through a browser of the client device.

At block 204, the method 200 includes determining a data throughput associated with the instrumented application. Data throughput is the amount of data logged or transmitted over a period of time (e.g., requests logged or transmitted per second, requests/s). The observability cluster, as further described in the description of FIG. 1, may determine the data throughput by calculating the number of requests over the period of time. In some examples, the observability cluster may determine the data throughput from the amount of data associated with the log over a period of time, such as the period of time the agent logged the data. In further examples, the observability cluster may determine the data throughput from the amount of data over a period time representing the application transmitting the log. The data throughput may be associated with the amount of data logged over a period of time, or the amount of data transmitted over a period of time.

At block 206, the method 200 includes comparing the data throughput to a first threshold. The first threshold may be predetermined and adjustable by administrators by providing input to the observability cluster. For example, administrators may set the first threshold to 1000 requests/s. In some examples, method 200 may further include comparing the data throughput to a second threshold, the second threshold being lower than the first threshold. By including a second threshold less than the first threshold, the observability cluster may maintain the data throughput of telemetry data within a predetermined range and adjust the data throughput by adjusting data sampling rate when the data throughput deviates from the predetermined range.

At block 208, the method 200 includes determining a reduced sampling rate to reduce the data throughput below the first threshold. For example, the dynamic sampling microservice further described in the description of FIG. 1 may generate a payload including instructions to adjust a sampling rate of an observability cluster to reduce the data throughput of the observability cluster below the first threshold. The observability cluster including an application performance monitoring server, may throttle logs or data from the instrumented application to reduce the data throughput based on the payload.

At block 210, the method 200 includes updating the application performance monitoring server to set a sampling rate to the reduced sampling rate. When the sampling rate is greater than the first threshold, the dynamic sampling microservice may generate instructions to the observability cluster to reduce the sampling rate to the reduced sampling rate. When the sampling rate is less than the second threshold, the dynamic sampling microservice may generate instructions to the observability cluster to adjust the sampling rate to an increased sampling rate. For example, an enterprise may have rules regarding a minimum amount of data the enterprise should monitor for a given application over a period of time. When there are fewer instances of the application, and therefore less telemetry data logged by agents, the dynamic sampling microservice may generate a payload including instructions to increase the sampling rate of the observability cluster.

### Illustrative System Architecture for Dynamic Sampling

FIG. 3 illustrates an example system architecture 300 for dynamic sampling. The system architecture 300 includes application services 303, observability cluster 306, and a dynamic sampling microservice 318.

The application services 303 may include one or more applications 304 executed as cloud services. The applications 304 include an agent associated with the application 304. By way of example, FIG. 3 includes three example applications 304: a Java application, a .net application, and a Python application. Further examples may include applications under languages such as but not limited to: Javascript, HTML5, C++, and SQL. Each application includes an associated agent.

The applications 304 may receive application requests 302, which may include requests from users of the applications to perform various actions. For example, an application request 302 may include logging into an application, setting up a profile, checking an account balance, and various other actions. The applications 304 may perform the application requests 302, and an agent associated with the applications 304 may log telemetry data associated with the execution of the application requests 302. In some examples, the telemetry data may also include data associated with background processes of the applications 304. The agent associated with the applications 304 may log the telemetry data according to a preset sampling rate. For example, an agent with a preset sampling rate of 0.5 may log 50% of the telemetry data it collects from the applications 304. The agent may provide the log of sampled telemetry data to the observability cluster 306.

The observability cluster includes one or more servers of cloud service provider infrastructure to provide performance monitoring of the application services 303 by analyzing the log of sampled telemetry data. In some examples, the observability cluster may include an application performance monitoring server 308, a database with search engine 310, and a cluster user interface 312.

The application performance monitoring server 308 may include one or more servers, provided by the cloud service provider infrastructure to monitor performance metrics (e.g., availability, reliability, security risks, and latency) of applications 304 provided by application services 303. In some examples, the application performance monitoring server 308 may include a sampling rate configured to throttle logs of sampled telemetry data from the applications 304 based on the application performance monitoring server 308 sampling rate.

The database with search engine 310 may allow administrators of the system architecture 300 to store and search application performance monitoring server 308 for sampled telemetry data. For example, administrators may use the database with search engine 310 to search for sampled telemetry data associated with application availability and review various attributes of the sampled telemetry data to troubleshoot availability issues of the application. The database and search engine 310 may be a software executed on cloud service provider infrastructure, including the application performance monitoring server 308. In some examples, the database and search engine 310 may be a proprietary analytics database such as Elasticsearch.

The cluster user interface 312 may provide administrators of the observability cluster to view and access telemetry data from the application performance monitoring server 308 and database with search engine 310. Administrators may provide inputs to the cluster user interface to query search results from the database with search engine 310. The cluster user interface may further include a computer program watcher 313, which may monitor data throughput from the applications 304. In some examples, the watcher 313 may determine the data throughput from the applications 304 by calculating the size of the data (e.g., in bytes) or the number of samples received by the application performance monitoring server 308 over a predetermined period of time. The watcher 313 may compare the data throughput to predetermined thresholds to determine whether the data throughput deviates from a predetermined range of data throughput.

When the watcher 313 determines the data throughput from the applications 304 deviates from the allowable range, the watcher 313 may trigger a webhook function 314. The webhook function 314 may cause the observability cluster to generate a payload requesting the dynamic sampling microservice 318 to adjust the sampling rate of the application performance monitoring server 308 such that the data throughput falls within a predetermined range of data throughput.

In some examples, the dynamic sampling microservice 318 may evaluate the payload and make an application programming interface (API) call to an agent configuration module 316 of the cluster user interface 312 to adjust the application performance monitoring server 308 sampling rate. In some examples, agent configuration module 316 may be part of the application performance monitoring server 308.

### Illustrative Block Diagram of Example Payloads to Adjust Sampling Rates

FIG. 4 illustrates a block diagram of demonstrating example payloads provided from the webhook function and the dynamic sampling microservice to adjust sampling rates. FIG. 4 includes an observability cluster 406, a cluster user interface 412, a webhook function 414, an agent configuration module 416, a dynamic sampling microservice 418, a webhook payload 420, and a dynamic sampling payload 422.

As further described in the description of FIG. 1 and FIG. 3, the observability cluster 406 may include various servers and processors to execute the cluster user interface 412. The cluster user interface 412 includes a graphical user interface by which administrators of the observability cluster 406 may interact with telemetry data received by the observability cluster. The cluster user interface 412 may trigger the webhook function 414 when a data throughput of telemetry data received by the observability cluster exceeds a predetermined threshold or deviates from a predetermined range. The webhook function 414 may generate the webhook payload 420 when triggered. The webhook payload is a packet or other data unit including information associated with the data throughput from an application and instructions to the dynamic sampling microservice 418 to reduce the sampling rate of an agent associated with the application.

The dynamic sampling microservice 418 may receive the payload and determine a new sampling rate for the observability cluster 406 that adjusts the data throughput to a rate that exceeds a predetermined threshold or deviates from a predetermined range. For example, the dynamic sampling microservice 418 may reduce the sampling rate of the observability cluster 406 for data associated with a first application and maintain the sampling rate for the observability cluster 406 of a second application. In further examples, the dynamic sampling microservice 418 may reduce the sampling rate based on types of telemetry data. For example, the observability cluster 406 may have different sampling rates for different types of telemetry data, such as telemetry data associated with user inputs to an application and telemetry data associated with performance of background processes.

The dynamic sampling microservice 418 generates the dynamic sampling payload 422 and may transmit the dynamic sampling payload 422 to the agent configuration module 416. The agent configuration module 416 may adjust the sampling rate of the observability cluster 406 based on the contents of the dynamic sampling payload 422. For example, the dynamic sampling payload 422 may include “transaction_sample_rate”: “0.3” which may instruct agents across multiple instances of an associated application to adjust the sampling rate of the observability cluster 406 to 30%.

Illustrative System Architecture for Dynamic Sampling with Incident Review

FIG. 5 illustrates an example system architecture 500 for dynamic sampling with incident review. The system architecture 500 includes application services 504, observability cluster 506, and a dynamic sampling microservice 518.

The example system architecture 500 for dynamic sampling with an incident review may include the system architecture 300 as described in the description of FIG. 3 as well as an incident review platform 520.

The example system architecture 500 may include application services 503 which may provide logs of sampled telemetry data to the observability cluster 506. As further described in the description of FIG. 3, the observability cluster 506 may include an application performance monitoring server, database with search engine, and cluster user interface. The observability cluster 506 may determine a data throughput of applications from the application services 503 based on the size of the log files provided by the application services 503.

The observability cluster 506 may include a watcher 513, which is a computer program that monitors the data throughput of applications from the application services 503 and triggers a webhook function 514 when the data throughput deviates from a predetermined range of allowable data throughput. The predetermined range of allowable data throughput may be established by administrators based on enterprise rules and government regulations regarding data collection and data retention.

The webhook function 514 may generate a payload (e.g., a packet or other data unit) including instructions to the dynamic sampling microservice to adjust the sampling rates of the observability cluster 506.

The webhook function 514 may transmit the payload to the incident review platform 520. The incident review platform 520 is a workflow platform by which administrators may review payloads to adjust the sampling rate of the observability cluster 506. Administrators may receive an alert that the webhook function 514 provided a payload and may manually review the payload. When administrators approve of the payload, the incident review platform 520 may provide the payload to the dynamic sampling microservice 518.

Based on the instructions received in the payload from the webhook function 514, the dynamic sampling microservice 518 may determine a sampling rate of the observability cluster to adjust the data throughput. The dynamic sampling microservice 518 may provide the additional payload to an agent configuration module which adjusts the sampling rate of the observability cluster 506.

### Example Advantages of Dynamic Sampling

Systems and methods for dynamic sampling are useful for enterprises because the systems and methods reduce the amount of storage used by the enterprise and the amount of transmitted data. Enterprises in industries that manage large quantities of data, such as banks, benefit from solutions that reduce the amount of data the enterprise stores and transmits. The more storage an enterprise requires, the more resources the enterprise must expend for the storage, so reductions in storage and transmission requirements of an enterprise saves the enterprise resources.

By adjusting the sampling rate when the system detects that data throughput is outside of a predetermined range, the system may reduce the amount of data it collects during time periods with higher data traffic. Further, by controlling the sampling rate of the observability cluster for applications provided through cloud services, enterprises are able to adjust data throughput during periods of higher data traffic without having to throttle application services or causing a loss in application services, thereby improving the user's experience.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

1. A method comprising:
providing, to a first client device, a first instance of a first instrumented application comprising a first agent, wherein the first agent is configured to log a first set of telemetry data associated with performance metrics of the first instance of the first instrumented application and a time period associated with the first set of telemetry data;
determining an overall data throughput associated with the first instrumented application based on the first set of telemetry data; and
comparing the overall data throughput to a first threshold, wherein when the overall data throughput exceeds the first threshold:
determine a reduced sampling rate to reduce the overall data throughput below the first threshold; and
update an application performance monitoring server to set a sampling rate of the application performance monitoring server to the reduced sampling rate;
comparing the overall data throughput to a second threshold lower than the first threshold, wherein when the overall data throughput is lower than the second threshold:
determine an increased sampling rate to increase the overall data throughput above the second threshold; and
update the application performance monitoring server to set the sampling rate to the increased sampling rate; and
when the overall data throughput does not exceed the first threshold or is not lower than the second threshold, store the first set of telemetry data in memory.

2. The method of claim 1, wherein the performance metrics of the first instrumented application include one or more of: latency, resource usage, and availability.

3. The method of claim 1, wherein when the overall data throughput does not exceed the first threshold:
retaining the first set of telemetry data based on enterprise rules associated with the first instrumented application when the overall data throughput does not exceed the first threshold.

4. The method of claim 1 further comprising:
providing, to a second client device, a second instance of the first instrumented application including a second agent, wherein the second agent is configured to log a second set of telemetry data and a time period associated with the second set of telemetry data, wherein the second set of telemetry data is associated with performance metrics of the second instance of the first instrumented application;
determining a data throughput associated with the second instance of the first instrumented application based on the second set of telemetry data; and
wherein the overall data throughput is based on the data throughput associated with the first instance of the first instrumented application and the data throughput associated with the second instance of the first instrumented application.

5. The method of claim 1 wherein when the overall data throughput exceeds the first threshold,
generate a request to set the sampling rate to the reduced sampling rate;
transmit the request; and
receive an approval to set the sampling rate to the reduced sampling rate.

6. The method of claim 1 further comprising:
providing, to a second client device, a first instance of a second instrumented application comprising a second agent, wherein the second agent is configured to log a second set of telemetry data associated with performance metrics of the second instrumented application and a time period associated with the second set of telemetry data;
determining a data throughput associated with the second instrumented application based on the second set of telemetry data; and
wherein the overall data throughput is based on the data throughput associated with the first instrumented application and the data throughput associated with the second instrumented application.

7. The method of claim 6, wherein when the data throughput is above the first threshold or below the second threshold, generate an alert associated with the first instrumented application.

8. A system comprising:
one or more processors configured to:
provide, to a first client device, a first instance of a first instrumented application comprising a first agent, wherein the first agent is configured to log a first set of telemetry data associated with performance metrics of the first instance of the first instrumented application and a time period associated with the first set of telemetry data;
determine an overall data throughput associated with the first instrumented application based on the first set of telemetry data; and
compare the overall data throughput to a first threshold, wherein when the overall data throughput exceeds the first threshold:
determine a reduced sampling rate to reduce the overall data throughput below the first threshold; and
update an application performance monitoring server to set a sampling rate of the application performance monitoring server to the reduced sampling rate;
compare the overall data throughput to a second threshold lower than the first threshold, wherein when the overall data throughput is lower than the second threshold:
determine an increased sampling rate to increase the overall data throughput above the second threshold; and
update the application performance monitoring server to set the sampling rate to the increased sampling rate; and
when the overall data throughput does not exceed the first threshold or is not lower than the second threshold, store the first set of telemetry data in memory.

9. The system of claim 8, wherein the performance metrics of the first instrumented application include one or more of: latency, resource usage, and availability.

10. The system of claim 8, wherein when the overall data throughput does not exceed the first threshold, the one or more processors are further configured to:
retain the first set of telemetry data based on enterprise rules associated with the first instrumented application when the overall data throughput does not exceed the first threshold.

11. The system of claim 8 wherein the one or more processors are further configured to:
provide, to a second client device, a second instance of the first instrumented application including a second agent, wherein the second agent is configured to log a second set of telemetry data and a time period associated with the second set of telemetry data, wherein the second set of telemetry data is associated with performance metrics of the second instance of the first instrumented application;
determine a data throughput associated with the second instance of the first instrumented application based on the second set of telemetry data; and
wherein the overall data throughput is based on the data throughput associated with the first instance of the first instrumented application and the data throughput associated with the second instance of the first instrumented application.

12. The system of claim 8, wherein when the overall data throughput exceeds the first threshold, the one or more processors are further configured to:
generate a request to set the sampling rate to the reduced sampling rate;
transmit the request; and
receive an approval to set the sampling rate to the reduced sampling rate.

13. The system of claim 8, wherein the one or more processors are further configured to:
provide, to a second client device, a first instance of a second instrumented application comprising a second agent, wherein the second agent is configured to log a second set of telemetry data associated with performance metrics of the second instrumented application and a time period associated with the second set of telemetry data;
determining a data throughput associated with the second instrumented application based on the second set of telemetry data; and
wherein the overall data throughput is based on the data throughput associated with the first instrumented application and the data throughput associated with the second instrumented application.

14. The system of claim 13, wherein when the data throughput is above the first threshold or below the second threshold, the one or more processors are further configured to:
generate an alert associated with the first instrumented application.

15. A non-transitory computer readable medium comprising instructions that when executed by one or more processors cause the one or more processors to:
provide, to a first client device, a first instance of a first instrumented application comprising a first agent, wherein the first agent is configured to log a first set of telemetry data associated with performance metrics of the first instance of the first instrumented application and a time period associated with the first set of telemetry data;
determine an overall data throughput associated with the first instrumented application based on the first set of telemetry data; and
compare the overall data throughput to a first threshold, wherein when the overall data throughput exceeds the first threshold:
determine a reduced sampling rate to reduce the overall data throughput below the first threshold; and
update an application performance monitoring server to set a sampling rate of the application performance monitoring server to the reduced sampling rate;
compare the overall data throughput to a second threshold lower than the first threshold, wherein when the overall data throughput is lower than the second threshold:
determine an increased sampling rate to increase the overall data throughput above the second threshold; and
update the application performance monitoring server to set the sampling rate to the increased sampling rate; and
when the overall data throughput does not exceed the first threshold or is not lower than the second threshold, store the first set of telemetry data in memory.

16. The non-transitory computer readable medium of claim 15, wherein the performance metrics of the first instrumented application includes one or more of: latency, resource usage, and availability of the first instrumented application.

17. The non-transitory computer readable medium of claim 15, comprising further instructions that when executed by one or more processors cause the one or more processors to:
retaining the first set of telemetry data based on enterprise rules associated with the first instrumented application when the overall data throughput does not exceed the first threshold.

18. The non-transitory computer readable medium of claim 15, comprising further instructions that when executed by one or more processors cause the one or more processors to:
provide, to a second client device, a second instance of the first instrumented application including a second agent, wherein the second agent is configured to log a second set of telemetry data and a time period associated with the second set of telemetry data, wherein the second set of telemetry data is associated with performance metrics of the second instance of the first instrumented application;
determine a data throughput associated with the second instance of the first instrumented application based on the second set of telemetry data; and
wherein the overall data throughput is based on the data throughput associated with the first instance of the first instrumented application and the data throughput associated with the second instance of the first instrumented application.

19. The non-transitory computer readable medium of claim 15, comprising further instructions that when executed by one or more processors cause the one or more processors to:
generate a request to set the sampling rate to the reduced sampling rate;
transmit the request; and
receive an approval to set the sampling rate to the reduced sampling rate.

20. The non-transitory computer readable medium of claim 15, comprising further instructions that when executed by one or more processors cause the one or more processors to:
providing, to a second client device, a first instance of a second instrumented application comprising a second agent, wherein the second agent is configured to log a second set of telemetry data associated with performance metrics of the second instrumented application and a time period associated with the second set of telemetry data;
determining a data throughput associated with the second instrumented application based on the second set of telemetry data; and
wherein the overall data throughput is based on the data throughput associated with the first instrumented application and the data throughput associated with the second instrumented application.
